(19) United States
(12) Patent Application Publication
(10) Pub. No.: US 2015/0256334 A1
(43) Pub. Date: Sep. 10, 2015

(54) CRYPTOGRAPHIC PROCESSES

(71) Applicant: Gautam Tendulkar, Epping (AU)

(72) Inventors: Simon Locke, Epping (AU); Gautam Tendulkar, Epping (AU)

(73) Assignee: COMMONWEALTH SCIENTIFIC AND INDUSTRIAL RESEARCH ORGANISATION, Campbell (AU)

(21) Appl. No.: 14/232,795

(22) PCT Filed: Jul. 13, 2012
(86) PCT No.: PCT/AU2012/000843

§ 371 Date: Aug. 12, 2014

(30) Foreign Application Priority Data
Jul. 14, 2011 (AU) 2011902809

(51) Int. Cl. H04L 9/08; H04L 9/30

(52) U.S. Cl. CPC H04L 9/0819; H04L 9/30; H04L 2209/24

(57) ABSTRACT

A process for sending via a communications network a public encryption key of a first node of the network to a second node of the network, the process being executed by the first node, and including the steps of: generating first audio-visual data representing at least one of an audio and a visual environment of the first node; applying a one-way function to the public encryption key and the first audio-visual data to generate first digest data; sending the first digest data to the second node; receiving from the second node confirmation that the first digest data was received by the second node; subsequent to the step of receiving the confirmation, sending the public encryption key and the first audio-visual data to the second node to allow the second node to determine that the public encryption key and the first audio-visual data were used to generate the first digest data; sending second audio-visual data to the second node, the second audio-visual data being different to but congruent with the first audio-visual data to allow the second node to determine that the second audio-visual data is congruent with the first audio-visual data, and consequently that the public encryption key received by the second node is that of the first node.

### TECHNICAL FIELD

The present invention relates to processes and systems for secure communication, including processes for receiving and sending encryption keys and for establishing a secure communications channel, such as may be used for secure video conferencing.

### BACKGROUND

Asymmetric encryption systems are known (e.g., public key encryption systems such as RSA) in which a party A (conventionally known as ‘Alice’) has a pair of keys: a public key, which a counterparty B (conventionally known as ‘Bob’) uses to encrypt messages intended for Alice; and a corresponding private or secret key that Alice can use to decrypt messages encrypted using the public key. A message encrypted using Alice's public key cannot in theory feasibly be decrypted other than with Alice's private key. Typically, counterparty Bob will also have a key pair, one of which he makes public for Alice, for example, to encrypt messages to him, and one he keeps private for decryption of messages encrypted with his public key. When Alice and Bob have each other's public encryption keys, they may proceed to exchange encrypted messages (for example, by email) which may, theoretically, only be decrypted by the intended recipient.

When the exchange of public keys can be conducted securely (e.g., face-to-face), the system as a whole is relatively secure. However, if Alice and Bob are remote from one another and communicating with one another by email, for example), there is the potential for an active eavesdropper (say, ‘Eve’) to compromise the security of the system in the following way. Assuming Eve is able to intercept all messages between Alice and Bob, when Alice and Bob initially exchange public keys, Eve can store the keys and substitute her own public key. Alice and Bob then believe that they have each other's public keys and they use them for communication. When Alice sends an encrypted message to Bob, it is intercepted by Eve, who is able to decrypt it using her private key, read it and then re-encrypt it using Bob's real public key before forwarding it to him. Communications from Bob to Alice are vulnerable in the same way. This type of attack on secure communication is known as a “Man in the Middle” attack.

In part to address these difficulties, infrastructures have been established (referred to as public key infrastructures or PKI) in which trusted third parties (TTP) serve as repositories of public keys, taking responsibility for ensuring that the public keys do in fact belong to the relevant parties. If Bob has provided his public key to such a TTP (and confirmed his identity), Alice may obtain it from the TTP. Alternatively, if the TTP also has Alice's public key, the TTP may provide to both Alice and Bob a session key, encrypted with their respective public keys. Once decrypted, this session key can be used both to encrypt and decrypt communications between Alice and Bob, and is therefore referred to as a symmetric encryption key.

Such systems rely, however, upon one or both parties having provided their public keys to the TTP. Furthermore, where the TTP provides a session key, the TTP itself (or a further party who manages to breach the TTP's security) may be able to decrypt communications encrypted using that session key.

There is thus a need for a mechanism by which parties desiring to communicate with one another may communicate cryptographic keys without fear of interception and substitution, and without using a third party.

It is desired, therefore, to provide a process for sending via a communications network a public encryption key of a first node of said network to a second node of said network, a process for receiving via a communications network a public encryption key of a first node of the network, and a communications system that alleviate one or more difficulties of the prior art, or that at least provide a useful alternative.

### SUMMARY

In accordance with some embodiments of the present invention, there is provided a process for sending via a communications network a public encryption key of a first node of said network to a second node of said network, the process being executed by the first node, and including the steps of:
generating first audio-visual data representing at least one of an audio and a visual environment of the first node;
applying a one-way function to the public encryption key and the first audio-visual data to generate first digest data;
sending the first digest data to the second node;
receiving from the second node confirmation that the first digest data was received by the second node;
subsequent to the step of receiving the confirmation, sending the public encryption key and the first audio-visual data to the second node to allow the second node to determine that the public encryption key and the first audio-visual data were used to generate the first digest data;
sending second audio-visual data to the second node, the second audio-visual data being different to but congruent with the first audio-visual data to allow the second node to determine that the second audio-visual data is congruent with the first audio-visual data, and consequently that the public encryption key received by the second node is that of the first node.

In some embodiments, the confirmation that the first digest data was received by the second node includes digest data generated by the second node from audio-visual data representing at least one of an audio and a visual environment of the second node. In other embodiments, the confirmation that the first digest data was received by the second node includes digest data generated by the second node from audio-visual data representing at least one of an audio and a visual environment of the second node and from a public encryption key of the second node.

In some embodiments, the process includes generating the public encryption key and a corresponding private encryption key at the beginning of a communications session, and disposing of at least the private encryption key at the end of the communications session.

In some embodiments, the generated private encryption key is only stored in volatile memory.

In some embodiments, the process includes:
receiving, from the second node, encrypted data encrypted by the second node using the public encryption key of the first node; and
decrypting the received encrypted data using the private encryption key of the first node.

In some embodiments, the encrypted data includes encrypted audio-visual data representing at least one of an audio and a visual environment of the second node, including at least one of streaming audio and streaming video of one or more participants in a teleconference or a video conference.

In some embodiments, the process includes the steps of:
receiving third digest data from the communications network, the third digest data purportedly being sent from the second node and generated by applying a one way function to the public encryption key of the second node and third audio-visual data representing at least one of an audio environment and a visual environment of the second node;
sending to the second node a confirmation of receipt of the third digest data;
Subsequent to the step of sending the confirmation of receipt to the second node, receiving via the communications network a public encryption key and audio-visual data, the received public encryption key purportedly being the public encryption key of the second node, and the received audio-visual data purportedly being the third audio-visual data of the second node;
applying the one-way function to the received encryption key and the received audio-visual data to generate fourth digest data;
comparing the third digest data to the fourth digest data to determine whether the received encryption key and the received audio-visual data were used to generate the second digest data; and
only if said step of comparing determines that the received encryption key and the received audio-visual data were used to generate the second digest data, then:
receiving from the communications network fourth audio-visual data representing at least one of the audio environment and the visual environment of the second node, and comparing the fourth audio-visual data with the received audio-visual data to assess their mutual congruence, and, based on the assessment, determining whether the received public encryption key is that of the second node.

In some embodiments, the third digest data provides the confirmation that the first digest data was received by the second node, and the public encryption key and the first audio-visual data sent to the second node provide the confirmation of receipt of the third digest data.

In accordance with some embodiments of the present invention, there is provided a process for receiving via a communications network a public encryption key of a first node of the network, the process being executed by a second node of the network and including the steps of:
receiving first digest data from the communications network, the first digest data purportedly being sent from the first node and generated by applying a one way function to the public encryption key of the first node and first audio-visual data representing at least one of an audio environment and a visual environment of the first node;
sending to the first node a confirmation of receipt of the first digest data;
subsequent to the step of sending the confirmation, receiving via the communications network a public encryption key and audio-visual data, the received public encryption key purportedly being the public encryption key of the first node, and the received audio-visual data purportedly being the first audio-visual data of the first node;
applying the one-way function to the received encryption key and the received audio-visual data to generate second digest data;
comparing the first digest data to the second digest data to determine whether the received encryption key and the received audio-visual data were used to generate the first digest data; and
only if said step of comparing determines that the received encryption key and the received audio-visual data were used to generate the first digest data, then:
receiving from the communications network second audio-visual data representing at least one of the audio environment and the visual environment of the first node, and comparing the second audio-visual data with the received audio-visual data to assess their mutual congruence, and, based on the assessment, determining whether the received public encryption key is that of the first node.

In accordance with some embodiments of the present invention, there is provided a process for establishing secure communications between first and second nodes of a communications network, the process being executed by the first node, and including the steps of:
sending via the communications network a public encryption key of a first node of said network to a second node of said network by executing any one of the above processes for sending; and
receiving via the communications network a public encryption key of the second node of the network by executing any one of the above processes for receiving, but with the first node acting as the second node, and vice-versa.

In accordance with some embodiments of the present invention, there is provided a process for establishing secure communications between a first party and a second party, wherein each party sends its public encryption key to the other party using any one of the above processes for sending, and each party receives the public encryption key of the other party using any one of the above processes for receiving, and wherein the sending steps are performed by the parties antiphonally.

In some embodiments, the audio-visual data being assessed for congruence are contiguous portions of an audio-visual data stream.

In some embodiments, the first audio-visual data represents request to communicate via the communications network.

In some embodiments, each said audio-visual data represents an audio and a visual environment of the corresponding node.

In accordance with some embodiments of the present invention, there is provided a communications system configured to execute any one of the above processes.

In accordance with some embodiments of the present invention, there is provided at least one computer-readable medium storing computer-executable instructions that, when executed by at least one processor of a computer system, cause the processor to execute any one of the above processes.

In accordance with some embodiments of the present invention, there is provided a communications system, including:
a first node of a communications network for use by a first party; and
a second node of a communications network for use by a second party;
wherein the first node is configured to send its public encryption key to the second party by executing any one of the above processes for sending, and wherein the second node is configured to receive the public encryption key of the first node by executing any one of the above processes for receiving.

In accordance with some embodiments of the present invention, there is provided a communications device configured for secure communications with at least one other communications device of the same type over a communications network, the communications device including:
an audio-visual input module configured to receive captured audio and/or video of the environment of the communications device;
   a hash component configured to generate first digest data by applying a one-way function to a public encryption key of the communications device and first audio-visual data representing the captured audio and/or visual environment of the communications device; and
a transmission component configured to send the first digest data to the other communications device, and, responsive to receipt of a confirmation that the first digest data was received by the other communications device, to send the public encryption key and the first audio-visual data to the other communications device to allow it to determine that the public encryption key and the first audio-visual data were used to generate the first digest data; and to send second audio-visual data to the other communications device, the second audio-visual data being different to but congruent with the first audio-visual data to allow the other communications device to determine that the second audio-visual data is congruent with the first audio-visual data, and consequently that the public encryption key received by the other communications device is that of the communications device.

Also described herein is a method for receiving an encryption key via a communications link, comprising the steps of:
a) receiving a first digest data item via the communications link;
b) subsequent to step a), receiving an encryption key and a first audio-visual data item via the communications link;
c) subsequent to step b), performing a one-way function on the encryption key and the audio-visual data item to generate a second digest data item and comparing the first and second digest data items to confirm that the encryption key and the first audio-visual data item were used to generate the first digest data item; and
d) subsequent to step c), receiving a second audio-visual data item, comparing it with the first audio-visual data item to determine a degree of congruence and, depending upon the degree of congruence, determining whether there is an eavesdropper active on the communications link.

Also described herein is a method for transmitting an encryption key via a communications link, comprising the steps of:
a) performing a one-way function on an encryption key and a first audio-visual data item to generate a first digest data item, and transmitting the first digest data item via the communications link:
b) subsequent to step a), transmitting the encryption key and the first audio-visual data item via the communications link;
c) subsequent to step b), transmitting a second audio-visual data item via the communications link, wherein the second audio-visual data item is congruent with the first audio-visual data item.

Also described herein is a method for establishing secure communications comprising receiving a remote party's encryption key by the above method for receiving and transmitting a local party's encryption key by the above method for transmitting.

Also described herein is a method for establishing a secure communications channel between a first party and a second party, wherein each party transmits a respective encryption key to the other party using the above method for transmitting and each party receives the others party by the above method for receiving, and wherein the transmission steps are performed by the parties antiphonally.

In each of the above aspects, the audio-visual data items are preferably contiguous audio-visual data, which are preferably generated contemporaneously with the other steps of the method. In a particularly preferred embodiment, the contiguous audio-visual data includes audio-visual data of a party desiring to communicate via the communications link.

Also described herein is a communications system comprising:
a communications channel;
a first computer system for use by a first party; and
a second computer system for use by a second party;
wherein the first computer system is adapted to transmit an encryption key to the second party by the method of the second aspect, and wherein the second computer system is adapted to receive the encryption key by the method of the first aspect.

The respective first and second audio-visual data items transmitted by the first and second computer systems are preferably contiguous audio-visual data, preferably generated by the first and second computer systems based upon their respective environments. In a particularly preferred embodiment, the respective contiguous audio-visual data transmitted by the first and second computer systems include audio-video streams of respective users of the first and second computer systems.

Also described herein is a method for receiving an encryption key via a communications link, comprising the steps of:
a) receiving a first digest data item via the communications link;
b) subsequent to step a), receiving an encryption key and a first audio-visual data item via the communications link;
c) subsequent to step b), performing a one-way function on the encryption key and the audio-visual data item to generate a second digest data item and comparing the first′ and second digest data items to confirm that the encryption key and the first audio-visual data item were used to generate the first digest data item; and
d) subsequent to step c), receiving a second audio-visual data item, and comparing it with the first audio-visual data item to assess the congruence of the first and second audio-visual data items and the security of the communications link.

### BRIEF DESCRIPTION OF THE DRAWINGS

Some embodiments of the invention will now be described, by way of example only, with reference to the accompanying drawings, in which:

FIG. 1 is a schematic representation of an embodiment of a communications system;

FIG. 2 is a flow diagram of a process for sending via a communications network a public encryption key of a first node of said network to a second node of said network;

FIG. 3 is a flow diagram of a process for receiving via a communications network a public encryption key of a node of the network;

FIG. 4 is a flow diagram illustrating the information flow in the steps occurring in an embodiment of a process for establishing a secure communications channel; and

FIG. 5 is a schematic diagram of a computer system in which embodiments of the present invention may be implemented.

### DETAILED DESCRIPTION

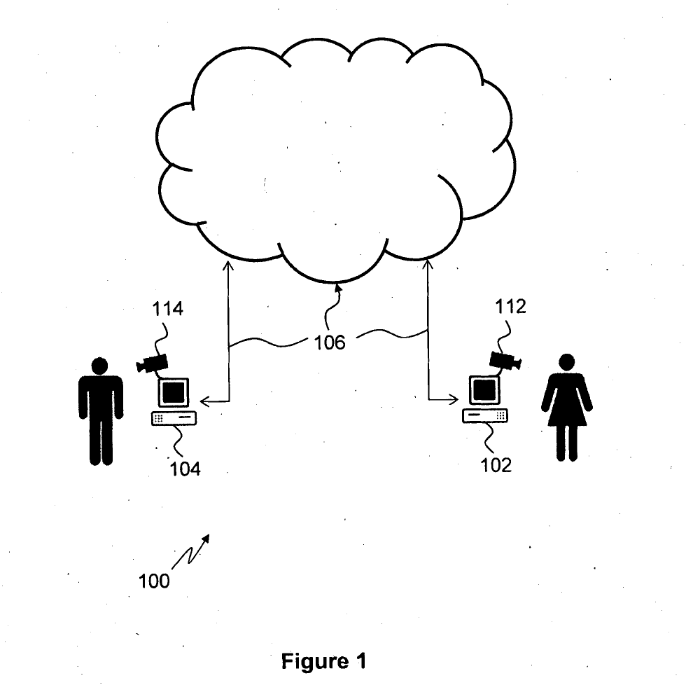

With reference to FIG. 1, a communications system 100 for secure communication between first and second parties includes a first node 102 for use by the first party (‘Alice’) and a second node 104 for use by the second party (‘Bob’), the first and second nodes 102, 104 being nodes of a communications network. In the described embodiments, each of the network nodes 102, 104 is also referred to herein as a “computer system”, where the scope of this term in this specification includes not only general purpose computers executing software instructions that cause the computer to behave as described below, but also devices and systems configured for more specific purposes, such as teleconference or video conference devices, systems, and/or hardware, mobile telephones and the like.

Between the computer systems 102, 104 is a communications channel 106 by which data is exchanged between the computer systems 102, 104. The communications channel 106 may be or include any form or forms of communications channel, including, for example, a fixed wire network, a wireless network, a telecommunications channel such as a mobile telecommunications channel, a TCP/IP communications channel via a computer network such as the Internet, or any combination of these. Thus the computer systems 102, 104 constitute respective nodes of a communications network.

In the specific example now described, the nodes 102, 104 are general purpose computers (for which the reference numerals 102, 104 will continue to be used) executing video telephony software that causes the computers 102, 104 to effect the processes described herein. In some embodiments, the software is a complete (perhaps open source) video telephony solution. In others, the processes described herein are provided by a plug-in module for an existing video telephony solution such as Skype.

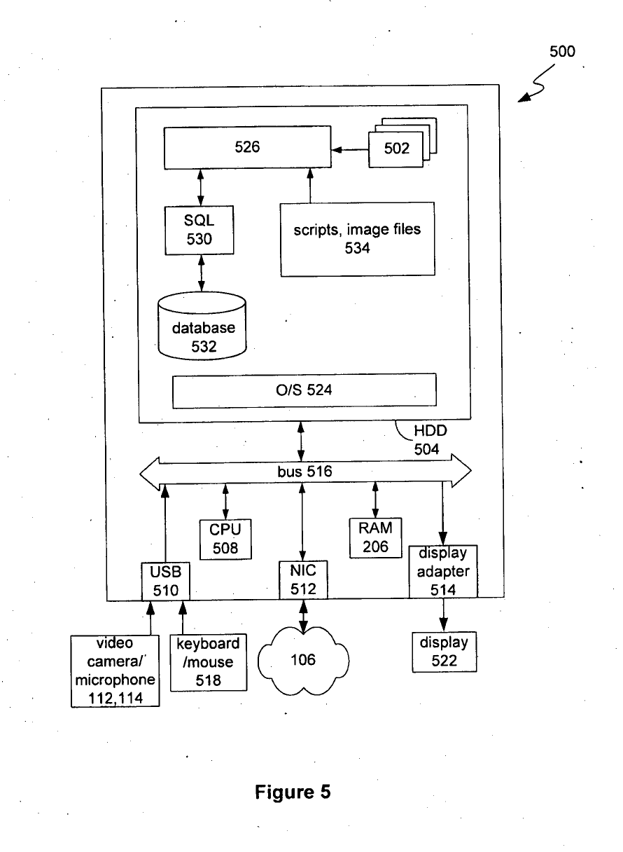

In the described embodiments, the standard computer systems are 32-bit or 64-bit Intel Architecture based computer systems 500, as shown in FIG. 5, and the described processor are implemented in the form of programming instructions of one or more software modules 502 stored on non-volatile (e.g., hard disk) storage 504 associated with the computer system, as shown in FIG. 5. However, it will be apparent that in other embodiments at least parts of the processes could alternatively be implemented as one or more dedicated hardware components, such as application-specific integrated circuits (ASICs) and/or field programmable gate arrays (FPGAs), for example.

Each of the computer systems 500 includes standard computer components, including random access memory (RAM) 506, at least one processor 508, and external interfaces 510, 512, 514, all interconnected by a bus 516. The external interfaces include universal serial bus (USB) interfaces 510, a network interface connector (NIC) 512 which connects the system 500 to a communications network such as the Internet, a display adapter 514, which is connected to a display device such as an LCD panel display 522.

At least one of the universal serial bus (USB) interfaces 510 is connected to a keyboard and a pointing device such as a mouse 518, at least one other being connected to a video camera and microphone 112, 114, which may be in the form of physically separate devices or an integrated video/audio capture device. In some embodiments, the microphone and video devices are integrated components internal to the computer system 500, as is the case, for example, where the computer system 500 is an Apple iMac desktop computer.

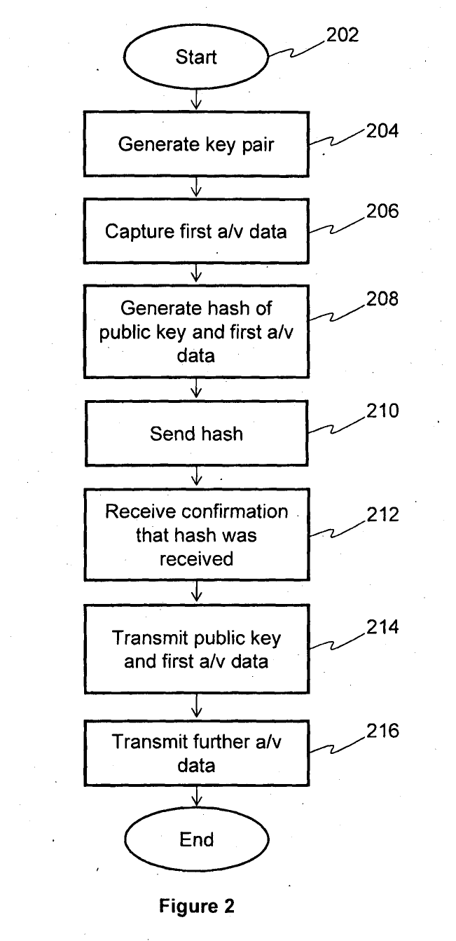

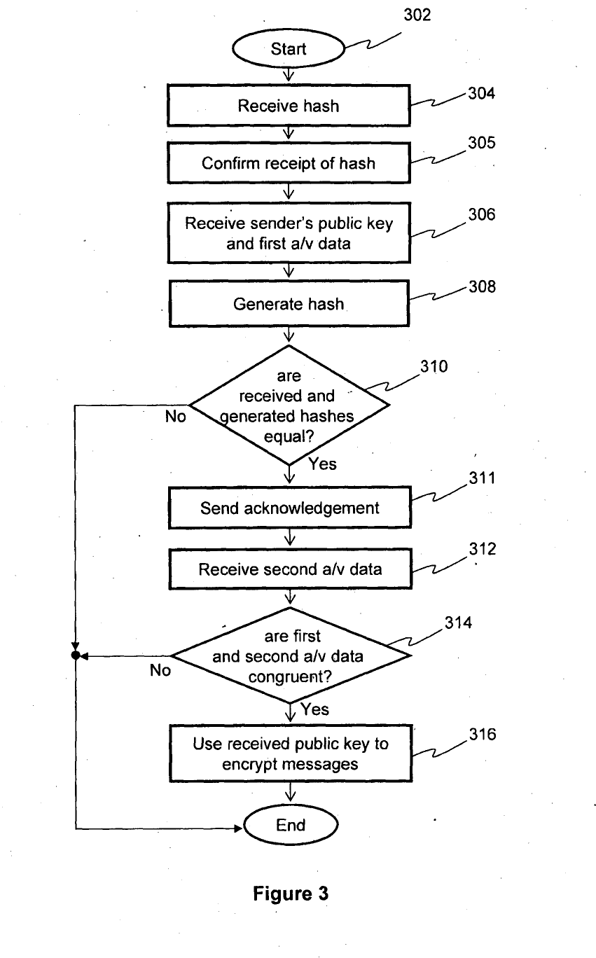

With reference to FIGS. 2 and 3, processes for transmitting and receiving public keys will now be described, followed by a description of an exemplary scenario in which the processes are used. In the following description, for convenience only, and unless the context indicates otherwise, it will be apparent that a reference to Bob can be understood as a reference to Bob's node or computer 104, and a reference to Alice can be understood as a reference to Alice's node or computer 102.

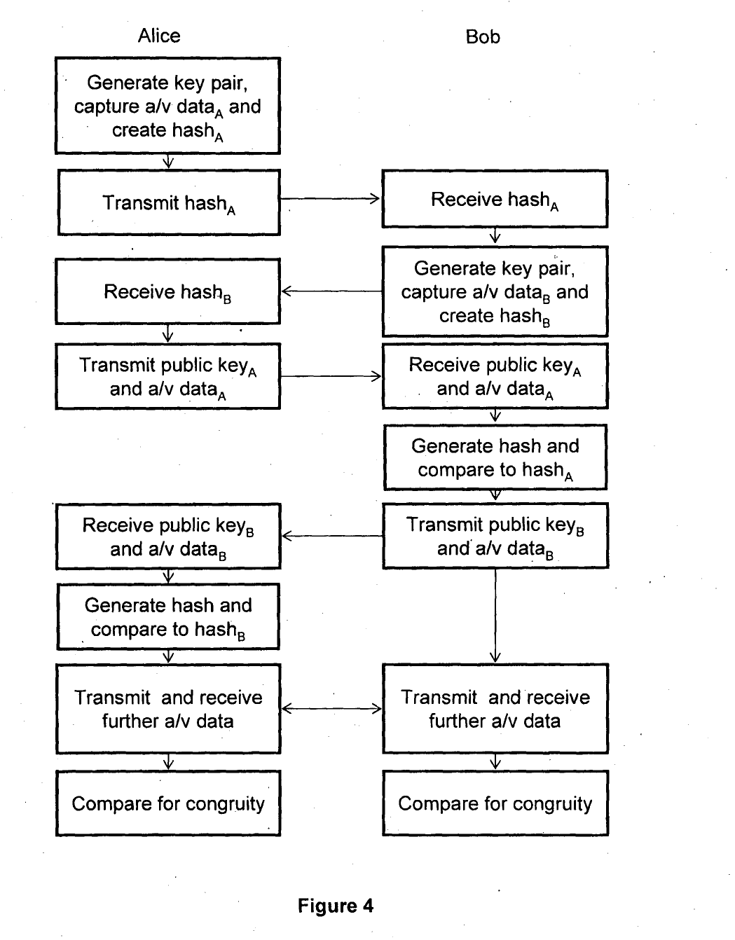

Turning to FIG. 2 (and with reference also to the data flow illustrated in FIG. 4), a process for transmitting a public key is initiated at step 202 when, for example, a user, Alice, of the first node 102 indicates (to the software 502) a desire to communicate securely with the user, Bob, of the second node 104. At step 204, Alice's node 102 generates a new public/private encryption key pair (P_{A},X_{A}) (e.g., an RSA key pair). The private key X_{A} is to be kept secret for decryption of received data, and in some embodiments is only ever stored temporarily in volatile RAM 506 for the duration of the communications session. The public key P_{A} is to be transmitted to the second node 104 for the encryption of data to be sent to Alice. At step 206, Alice's node 102 generates first audio-visual data representing at least one of its audio and its visual environment, using the associated microphone and/or camera 112.

In general, the term “audio-visual” as used in this specification is to be construed broadly as encompassing:(i) audio only, (ii) visual only, and (iii) both audio and visual. The term “visual” in this context means purely visual or image information without an audio component, and most broadly means at least one image or video frame but is typically a sequence of temporally contiguous video frames; e.g., a video stream.

In this specification, the terms “audio environment” and “visual environment” in respect of a node/computer system and/or its user refer respectively to audio information and visual information capable of being captured by a microphone and pure imaging device (i.e., without sound), respectively, and being capable of distinguishing the environment of the node/computer system itself and/or its user from the environments of other nodes/computer systems and/or their users.

In the described example scenario, and most typically, the first audio-visual data represents both visual and audio information of Alice herself (being deemed a part of the ‘environment’ of her node 102) and optionally also of her immediate surroundings. That is, the visual component of the first audio-visual data represents at least one image (and typically a sequence of video frames, more typically being a portion of a ‘live’ video stream) of Alice herself, and optionally also her immediate surroundings (e.g., the room she is in and associated furniture/decor, the chair she is sitting in, etc). The audio component of the first audio-visual data thus represents the accompanying sounds of Alice and/or her environment; for example, Alice talking and/or music and/or ambient sounds (musical or otherwise) of Alice's environment. Where the audio includes music, the music component may be ambient music playing in Alice's environment, and in some embodiments includes a music file stored on Alice's computer 106 that is played by the software 502. The music file may be one of a plurality of music files randomly selected by the software 502.

At step 208, using a one-way function (e.g., the cryptographic hash algorithms SHA-2 family of functions), Alice's node 102 generates at least one hash H₁ as a function of at least a portion of the captured first audio-visual data (e.g., the visual component may be a predetermined frame, a predetermined number of consecutive frames, or a predetermined scheme of non-consecutive frames, but most typically a portion of a live stream of video with accompanying audio) and of Alice's public key P_{A}. For convenience of description, the hash H₁ is generally described herein as being a single hash H₁. However, where the first audio-visual data represents a relatively long portion of streaming video, multiple hashes may need to be generated; however, only one of them (e.g., the first one) needs to include Alice's public key.

At step 210, Alice's node 102 transmits the hash H₁ via the communications link 110 to Bob's node 104. Bob's node 104 receives the hash H₁ and in response issues an acknowledgement confirming receipt of the hash H₁. The acknowledgement/confirmation is then received at Alice's node 102 at step 212.

As it is important that the acknowledgement confirming receipt is genuinely from Bob's node 104 and not from a man-in-the-middle eavesdropper ‘Eve’, in the described embodiments the acknowledgement is provided in the form of an audio-visual confirmation from Bob himself that the hash has been received, so that Alice and/or Alice's software 502 can be confident that Bob has indeed received the hash H₁.

Only after Alice has received Bob's confirmation of receipt of the hash H1, then at step 214 Alice's node 102 transmits the public key P_{A} and the first audio-visual data that were used to generate the hash H₁, and, at step 216, continues to transmit audio-visual data (referred to herein as ‘second’ audio-visual data to avoid confusion) captured by the camera/microphone 112 and congruent with the first audio-visual data that was used to generate the hash H₁. By congruent is meant that it can be determined by a remote party (in this case, Bob himself and/or Bob's node 104) that the source of the audio-visual data is the same. Typically, this will be the case where the first and second audio-visual data are contiguous respective portions of a stream of audio-visual data, such that there is temporal continuity between the first and second audio-visual data, but this might not always be the case in other embodiments.

For example, it may be apparent to a viewer of the audio-visual data that the data is of a single source or origin, even if the audio-visual data is not continuous in a temporal sense. The audio-visual data may, for example, include video of Alice or Bob in which details of their background, attire, etc are visible. In such cases, a viewer may be able to determine that the audio-visual data is of a single source or origin, notwithstanding a small temporal discontinuity. Alternatively or additionally, congruence can be assessed by a computer or other processing device analysing one or more properties of the audio-visual data, for example, pixel colour and brightness. Congruence can also be assessed, at least in part, using an audio component of the audio-visual data captured by the camera/microphone 112 to overcome difficulties caused, for example, by Alice being silent at the time of capture. As described above, this audio component may include audio generated from an audio file stored on Alice's computer 102. Similarly, a video file stored on Alice's computer 106 can be used to assess congruence, rather than, or in addition to, captured video of Alice, although the use of stored information alone may be less robust than using the ‘live’ or real-time visual and/or audio environment.

In the described example scenario, the first and second audio-visual data are contiguous portions of a live video stream (with audio) showing Alice and perhaps also of part of her surroundings, being initial portions of the same video stream that will constitute Alice's contributions to the video conference, once established.

Turning to FIG. 3, a process for receiving a public key (for example, the Alice's transmitted public encryption key as discussed above) will now be described. In the described embodiments, Bob's node 104 commences the process for receiving the key at step 302, in response to receiving a request to establish a secure communications channel. In one embodiment, assuming that Alice's node 102 has transmitted a hash H₁ at step 210 of the process discussed above with reference to FIG. 2, the receipt of that hash by Bob's node 104 at step 304 provides the request.

At step 305, Bob confirms or acknowledges receipt of the hash. As described above, in some embodiments, this can be an automated acknowledgement generated and sent by Bob's computer 108. However, in the described embodiments, the acknowledgement is in the form of, or at least includes, audio-visual data representing Bob's verbal and visual acknowledgement of receipt of the hash, so that Alice can be confident that Bob genuinely has received the hash H₁, rather than a man-in-the-middle eavesdropper. As described below, such audio-visual data from Bob may also be in the form of a hash, and the unhashed audio-visual data sent subsequently.

As discussed above, once Alice's node 102 receives Bob's confirmation of receipt of the hash, it transmits the public key P_{A} and the first audio-visual data that was used to generate the hash H1. They are received by Bob's node 104 at step 306.

At step 308, Bob's node 104 uses the same one-way function that was used by Alice's node 102 and in the same way to generate a hash of the received public key P_{A} and the received first audio-visual data.

At step 310, Bob's node 104 compares the received and the generated hashes. If they are equal to one another, Bob's node 104 deduces that the public key P_{A} and the first audio-visual data that it received are the same as were used to generate the hash H₁, and sends a corresponding acknowledgement to Alice's node 102 at step 311. However, Bob's node 104 is not yet able to be sure that the hash, the audio-visual data and the public key were all not substituted by an eavesdropper.

At step 312, Bob's node 104 receives further or second audio-visual data from Alice's node 102 (sent by Alice in response to receipt of Bob's acknowledgement sent at step 311), and then, at step 314, the first and second audio-visual data are compared to assess their mutual congruence. In some embodiments, this step is performed automatically by Bob's node 104 (e.g., by comparison of one or more selected properties of the audio-visual data; for example, pixel brightness and colour or spatial distributions thereof). In other embodiments, the assessment is performed manually by Bob, who compares the first and second audio-visual data to determine whether they are congruent (e.g., that they are of the same subject, that the background is the same and that there are no temporal discontinuities in the visual and audio components). In some embodiments, this comparison can be facilitated by the software 502 displaying the first and second audio-visual data in a picture-in-picture or split screen arrangement. In some embodiments, the data is checked in both ways. In the described example scenario where the first and second audio-visual data are contiguous portions of a live video stream (with audio) of Alice, it is usually readily straightforward for Bob (and any other co-located participants) to manually assess whether the two portions of the video stream of Alice are congruent. However, as a precaution, the software 502 can also be configured to automatically compare the two portions of the video stream to look for any discontinuities or other forms of inconsistency between them, and to generate an alert if any is found.

In any event, once it has been established that the data are congruent, it follows that the data now being received from Alice's node 102 was generated in the same way as was the data that was used to generate the hash H₁. Furthermore, since the data that was used to generate the hash was not transmitted until after the hash had been received by Bob, it follows that the received public key P_{A} was also the public key used by Alice's node 102 to generate the hash. That is to say, the public key received by Bob has not been substituted by a man-in-the-middle eavesdropper but is genuinely Alice's public key.

While the foregoing description has made reference to a key being transmitted by Alice's node 102 and being received by Bob's node 104, it will be apparent that Bob's node 104 may also execute the process of FIG. 2 to generate and transmit a public encryption key that is received by Alice's node 102 using the process of FIG. 3, thereby providing an overall secure communications process such as the one shown in FIG. 4, as is the case in the described video conferencing example scenario. In such cases, the transmission of the hash of Bob's public encryption key and first audio-visual data by Bob's node 104 at step 210 of the transmission process may be performed in response to receipt of the hash from Alice's node 104 and the receipt of Bob's hash by Alice therefore also serves the purpose of securely acknowledging receipt of the hash from Alice's node 102 (i.e., step 305 of the receiving process). In this arrangement, both the initiating and the responding nodes 102, 104 execute the same processes, but in which the various steps where hashes and audio-visual data are transmitted to the other party are interleaved or performed antiphonally, as shown in FIG. 4, thereby further enhancing the security of the processes.

Accordingly, as shown in FIG. 4, in response to receipt of Bob's hash, Alice then sends to Bob her public key and first audio-visual data, and when Bob receives those, he generates a corresponding hash and compares it to the hash he received from Alice, and only if the hashes match does Bob then send his own public key and first audio-visual data to Alice. Alice then generates a hash of Bob's public key and first audio-visual data and compares them to the hash previously received from Bob. Only if the hashes match does Alice then continue to send further audio-visual data to Bob.

As an alternative to such two-way processes, once Bob's node 104 has securely received Alice's public key as described above, Bob's node 104 can simply (generate and) encrypt Bob's public key with Alice's public key, and send the encrypted key to Alice, so that only Alice can determine Bob's public key. Alternatively, Bob's node 104 can generate a symmetric session key (perhaps from Alice's public key), encrypt that with Alice's public key, and send the encrypted key to Alice for subsequent encrypted communications. In either case, Bob's confirmation of receipt of Alice's hash at step 212 can still include audio-visual data representing Bob's audio-visual confirmation of Alice's hash.

Once the public encryption keys have been exchanged by the processes described above, further communication (e.g., video conferencing) can be encrypted using the public keys so exchanged. The public keys may then also be used to encrypt documents to be transmitted between the parties. In some embodiments, a session key (i.e., a symmetric encryption key) is agreed securely between the parties using the public keys to reduce the volume of traffic encrypted using the public encryption keys.

It will be apparent from the above description that the described processes can be used to provide secure communications between parties without using a third party to provide public keys. Indeed, the public and private encryption key pairs can be generated on demand at the beginning of a communications session, and in some embodiments are only temporarily stored in volatile memory of the communicating nodes. The keys, in particular the private keys, can then be securely destroyed at the end of the communications session.

The described processes are particularly suited to videoconferencing, where the audio-visual data includes ‘live’ streaming audio and video of the conference participants, and these are used to assess congruence, either by the human participants or by the participating nodes themselves, or both. The encryption key pairs can be generated once at the beginning of a communications session, or in some embodiments can be generated multiple times during the one session, either periodically, randomly, and/or in response to the arrival of a new participant in the conference and/or in response to the departure of an existing participant, and/or in response to an input from one of the participants, for example.

Moreover, one or more of the participants need not be human. For example, the described processes can be used, for example, in unmanned aircraft, drones, or other vessels or vehicles, where it is undesirable to have a private key stored in persistent memory in case of capture. In one embodiment, a computer in, an unmanned aircraft (Bob) generates a key pair on the fly and transmits its public key to its controller Alice using the processes described above. In such cases, the audio-visual data can include video captured by an onboard camera, for example, before or during take-off, showing the view of the camera of ground activity that is verifiable by Alice (for example, particular ground crew activity, perhaps with an aircraft identifier on the body or wing of the aircraft within the field of view of the camera). Alice's public key can be sent to the aircraft using the processes described above, requiring the use of automated processes by Bob to assess congruence of audio-visual data received from Alice. Many suitable processes for comparing audio and/or video data to assess congruence will be apparent to those skilled in the art.

In yet further embodiments, the software 502 implementing the processes described above includes the public key of a body such as a government body authorised to intercept communications. Alternatively, the described processes can be used in a tri-partite mode to allow authorised intercepts or, indeed, in a more general multi-partite mode communication among three or more parties.

Many modifications will be apparent to those skilled in the art without departing from the scope of the present invention.

1. A process for sending via a communications network a public encryption key of a first node of said network to a second node of said network, the process being executed by the first node, and comprising the steps of:
generating first audio-visual data representing at least one of an audio and a visual environment of the first node;
applying a one-way function to the public encryption key and the first audio-visual data to generate first digest data;
sending the first digest data to the second node;
receiving from the second node confirmation that the first digest data was received by the second node;
subsequent to the step of receiving the confirmation, sending the public encryption key and the first audio-visual data to the second node to allow the second node to determine that the public encryption key and the first audio-visual data were used to generate the first digest data;
sending second audio-visual data to the second node, the second audio-visual data being different to but congruent with the first audio-visual data to allow the second node to determine that the second audio-visual data is congruent with the first audio-visual data, and consequently that the public encryption key received by the second node is that of the first node.

2. The process of claim 1, wherein the confirmation that the first digest data was received by the second node comprises digest data generated by the second node from audio-visual data representing at least one of an audio and a visual environment of the second node.

3. The process of claim 1, wherein the confirmation that the first digest data was received by the second node comprises: digest data generated by the second node from audio-visual data representing at least one of an audio and a visual environment of the second node and from a public encryption key of the second node.

4. The process of claim 1, comprising generating the public encryption key and a corresponding private encryption key at the beginning of a communications session, and disposing of at least the private encryption key at the end of the communications session.

5. The process of claim 4, wherein the generated private encryption key is only stored in volatile memory.

6. The process of claim 1,
receiving, from the second node, encrypted data encrypted by the second node using the public encryption key of the first node; and
decrypting the received encrypted data using the private encryption key of the first node.

7. The process of claim 6, wherein the encrypted data comprises encrypted audio-visual data representing at least one of an audio and a visual environment of the second node, comprising at least one of streaming audio and streaming video of one or more participants in a teleconference or a video conference.

8. The process of claim 1, comprising the steps of:
receiving third digest data from the communications network, the third digest data purportedly being sent from the second node and generated by applying a one way function to the public encryption key of the second node and third audio-visual data representing at least one of an audio environment and a visual environment of the second node;
sending to the second node a confirmation of receipt of the third digest data;
subsequent to the step of sending the confirmation of receipt to the second node, receiving via the communications network a public encryption key and audio-visual data, the received public encryption key purportedly being the public encryption key of the second node, and the received audio-visual data purportedly being the third audio-visual data of the second node;
applying the one-way function to the received encryption key and the received audio-visual data to generate fourth digest data;
comparing the third digest data to the fourth digest data to determine whether the received encryption key and the received audio-visual data were used to generate the second digest data; and
only if said step of comparing determines that the received encryption key and the received audio-visual data were used to generate the second digest data, then:
receiving from the communications network fourth audio-visual data representing at least one of the audio environment and the visual environment of the second node, and comparing the fourth audio-visual data with the received audio-visual data to assess their mutual congruence, and, based on the assessment, determining whether the received public encryption key is that of the second node.

9. The process of claim 8, wherein the third digest data provides the confirmation that the first digest data was received by the second node, and the public encryption key and the first audio-visual data sent to the second node provide the confirmation of receipt of the third digest data.

10. A process for receiving via a communications network a public encryption key of a first node of the network, the process being executed by a second node of the network comprising and the steps of:
receiving first digest data from the communications network, the first digest data purportedly being sent from the first node and generated by applying a one way function to the public encryption key of the first node and first audio-visual data representing at least one of an audio environment and a visual environment of the first node;
sending to the first node a confirmation of receipt of the first digest data;
subsequent to the step of sending the confirmation, receiving via the communications network a public encryption key and audio-visual data, the received public encryption key purportedly being the public encryption key of the first node, and the received audio-visual data purportedly being the first audio-visual data of the first node;
applying the one-way function to the received encryption key and the received audio-visual data to generate second digest data;
comparing the first digest data to the second digest data to determine whether the received encryption key and the received audio-visual data were used to generate the first digest data; and
only if said step of comparing determines that the received encryption key and the received audio-visual data were used to generate the first digest data, then:
receiving from the communications network second audio-visual data representing at least one of the audio environment and the visual environment of the first node, and comparing the second audio-visual data with the received audio-visual data to assess their mutual congruence, and, based on the assessment, determining whether the received public encryption key is that of the first node.

11. A process for establishing secure communications between first and second nodes of a communications network, the process being executed by the first node, and comprising: the steps of:
sending via the communications network a public encryption key of a first node of said network to a second node of said network by executing the process of any of claim 1; and
receiving via the communications network a public encryption key of the second node of the network, but with the first node acting as the second node, and vice-versa.

12. A process for establishing secure communications between a first party and a second party, wherein each party sends its public encryption key to the other party using the process of claim 1, and each party receives the public encryption key of the other party, wherein the sending steps are performed by the parties antiphonally.

13. The process of any claim 1, wherein the audio-visual data being assessed for congruence are contiguous portions of an audio-visual data stream.

14. The process of claim 13, wherein the first audio-visual data represents request to communicate via the communications network.

15. The process of claim 1, wherein each said audio-visual data represents an audio and a visual environment of the corresponding node.

16. A communications system configured to execute the process of claim 1.

17. At least one tangible computer-readable medium storing computer-executable instructions that, when executed by at least one processor of a computer system, cause the processor to execute the process of claim 1.

18. A communications system comprising:
a first node of a communications network for use by a first party; and
a second node of a communications network for use by a second party;
wherein the first node is configured to send its public encryption key to the second party by executing the process of claim 1, and wherein the second node is configured to receive the public encryption key of the first node.

19. A communications device configured for secure communications with at least one other communications device of the same type over a communications network, the communications device comprising:
an audio-visual input module configured to receive captured audio and/or video of the environment of the communications device;
a hash component configured to generate first digest data by applying a one-way function to a public encryption key of the communications device and first audio-visual data representing the captured audio and/or visual environment of the communications device; and
a transmission component configured to send the first digest data to the other communications device, and, responsive to receipt of a confirmation that the first digest data was received by the other communications device, to send the public encryption key and the first audio-visual data to the other communications device to allow it to determine that the public encryption key and the first audio-visual data were used to generate the first digest data; and to send second audio-visual data to the other communications device, the second audio-visual data being different to but congruent with the first audio-visual data to allow the other communications device to determine that the second audio-visual data is congruent with the first audio-visual data, and consequently that the public encryption key received by the other communications device is that of the communications device.

20. The process of claim 2, comprising generating the public encryption key and a corresponding private encryption key at the beginning of a communications session, and disposing of at least the private encryption key at the end of the communications session.
